(19) United States
(12) Patent Application Publication
(10) Pub. No.: US 2002/0184087 A1
(43) Pub. Date: Dec. 5, 2002

(54) Rental business of special portable terminal unit for travel, using passport information

(76) Inventor: Nobuaki Kasai, Higashi-Ku (JP)

Correspondence Address: Nobuaki Kasai, 4-1-36, FUKO 7-JYO, HIGASHI-KU, SAPPORO, HOKKAIDO, 007-0867, JP

(21) Appl. No.: 09/839,548

(22) Filed: Apr. 19, 2001

(51) Int. Cl. G06F 17/60

(52) U.S. Cl. 705/14

(57) ABSTRACT

The system to rent GPS/Web-corresponding Special Portable Terminal Units for Travel (hereafter, referred to as “Portable Units”) based on the travelers' passports to go abroad. The renter of Portable Units (“Renter”) uses the scanner of computers in which the contract program has been installed previously to read the information contained in a traveler's passport to Portable Unit on a contract base.

### BACKGROUND OF THE INVENTION

This invention is concerned with the rental business to make a rental contract of Special Portable Terminal Units for Travelers easier, by using the information in passports.

To get any information on the destination, shopping, restaurants when people travel abroad, they have to read a travel guide book or use PC for Internet. However, recently, a new multi-purpose Portable Terminal Unit has been developed.

The existing system has the following problems:

Since the general-purpose Portable Terminal Units are expensive, the procedure for renting is complex or people must pay expensive security money. Besides, the software for memory chips has not been developed well and such units have never been practical. This Invention will eliminate the above defects so that newly-developed Portable Terminal Units may be rented and used easily in a wide range.

### SUMMARY OF THE INVENTION

The system regarding claim Item 1, claim Item2 and claim Item 3 in this application:

The system to rent GPS/Web-corresponding Special Portable Terminal Unit for Travel ( hereafter, referred to as “Portable Unit”) based on the traveler's passports to go abroad. The renter of Portable Units ( hereafter, referred to as “Renter”) installs a Server on the internet in advance and inputs the information contained in a traveler's passport into the Server as data base when they make a contract with the traveler regarding the rental Portable Unit. As the information in passports is the best material for a reference of a person, the procedure to execute any documents, including an agreement, will be easy. A kind of rental business using the passport information, featuring that Renter rents Portable Units, with or without charge, after the execution of agreement.

If such information in passports is kept as data base by Renter, according to the traveler's request, the Unit may be rented without any agreement paper.

A traveler may use Portable Unit and access Server to get his/her own information in the passport at any time, anywhere, if necessary. Also, Renter may grasp the present location of Portable Unit if necessary.

The Rental Business of Special Portable Terminal Units for a traveler , using the passport information, composed of the above systems.

### DETAILED DESCRIPTION OF THE INVENTION

The practical execution forms of this Invention are as follows:

A) The Renter (10) of Portable Units(13) set Server (11) on Internet previously. The Server (11) is equipped with the data base (12) concerning a travel abroad, including information on sightseeing places, shopping, restaurants, hotels, rental cars, police stations and Embassies, etc.

B) A program in which a traveler can apply for the rental Portable Unit, using Passport information(14), is previously input in the Server concerned.

C) A traveler (15) who requests the rental Portable Unit (13) visits the Renter (10) to apply for it directly. In application, the information in the passport is scanned and input in the Server to execute the rental agreement.

D) The data to be input in Portable Unit (13) is set up by selecting memory chips which are storing the data of destination or visiting places. Such data is obtained by travelers by directly accessing to Server (11).

E) Portable Units (13) may be handed to the traveler in the Renter's office immediately after making of an agreement or may be handed in the air port, depending on the traveler's request. At that time, ID No. for access is given to the traveler.

F) If a traveler has lost the passport or the passport has been stolen, he/she is able to get the passport information by accessing Server (11) with Portable Unit (13).

G) Renter(10) may search for the location of Portable Unit (13) if necessary.

H) A traveler (15) returns Portable Unit (13) to Renter(10) after returning home. At that time, the traveler may select whether the information based on the passport should be deleted or not . If he/she asks the Renter to keep the data, it is possible to rent Portable Unit (13) again in the next time only by a simple procedure.

As other services related with the passport information, the system may be applied to the reservation of air tickets/hotels/restaurants and the payments for meals/hotels.

A traveler does not need to make complex documents when applying for the rental Portable Unit, just by showing his/her passport. Also, Renter has no worry about renting because they rent Portable Units according to the passport information which is most reliable as the personal information source.

If a traveler has lost the passport or has been involved in an accident, he/she can get the passport information and other important information by accessing the Server. Also, Renter can search the current location of Portable Units if necessary. Therefore, the system is very convenient for travelers.

### Simple Description of Figures

FIG. 1 System structure concerned with the execution form of this Invention.

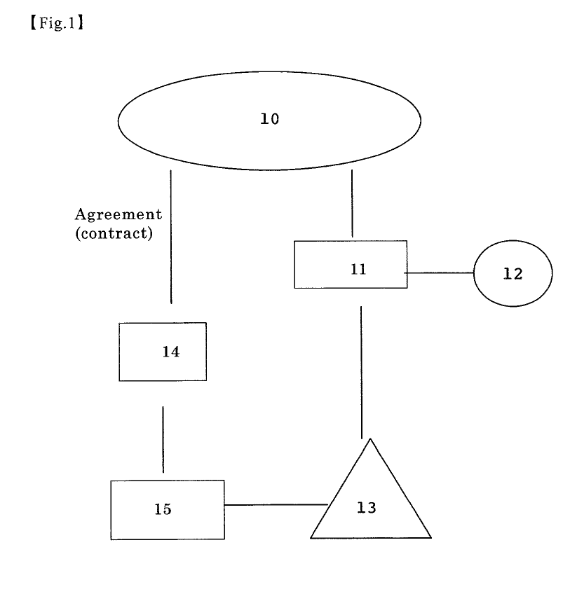

### Description of Numbers

10 Renter
11 Server
12 Data Base
13 Portable Unit
14 Passport
15 Traveler

What is claimed is:

1. The system to rent GPS/Web-corresponding Special Portable Terminal Units for Travel ( hereafter, referred to as “Portable Units”) based on travelers' passports to go abroad. The renter of Portable Units ( hereafter, referred to as “Renter”) installs a Server on the Internet in advance and inputs the information contained in a traveler's passport into the Server as data base when they make a contract with the traveler regarding the rental Portable Unit. As the information in passports is the best material for a reference of a person, the procedure to execute any documents, including an agreement, will be improved to be easy and quicker . A kind of rental business using the passport information, featuring that Renter rents Portable Unit , with or without charge, after the execution of agreement.

2. Rental Business of Special Portable Terminal Unit for travelers, using the passport information as mentioned in Application Item 1, featuring that travelers may rent such Portable Units without any contract at the 2^{nd} time, if the data-base information is kept by Renter , according to the traveler's request.

3. A traveler may use Portable Unit and access Server to get the information written in the passport at any time, anywhere, if necessary. Also, Renter may grasp the present location of Portable Units if necessary. The Rental Business of Portable Terminal Units for a traveler only, using the passport information as mentioned in Application Item 1.
